(19) United States
(12) Patent Application Publication
(10) Pub. No.: US 2014/0250110 A1
(43) Pub. Date: Sep. 4, 2014

(54) IMAGE ATTRACTIVENESS BASED INDEXING AND SEARCHING

(71) Applicants: Linjun Yang, Beijing (CN); Bo Geng, Beijing (CN); Xian-Sheng Hua, Bellevue, WA (US); Shipeng Li, Beijing (CN)

(72) Inventors: Linjun Yang, Beijing (CN); Bo Geng, Beijing (CN); Xian-Sheng Hua, Bellevue, WA (US); Shipeng Li, Beijing (CN)

(21) Appl. No.: 13/394,425

(22) PCT Filed: Nov. 25, 2011
(86) PCT No.: PCT/CN11/82909

§ 371 Date: Mar. 6, 2012

(51) Int. Cl. G06F 17/30

(52) U.S. Cl. CPC G06F 17/30268; G06F 17/30321; G06F 17/30554
USPC 707/723; 707/736; 707/741

(57) ABSTRACT

Attractiveness of an image may be estimated by integrating extracted visual features with contextual cues pertaining to the image. Image attractiveness may be defined by the visual features (e.g., perceptual quality, aesthetic sensitivity, and/or affective tone) of elements contained within the image. Images may be indexed based on the estimated attractiveness, search results may be presented based on image attractiveness, and/or a user may elect, after receiving image search results, to re-rank the image search results by attractiveness.

### RELATED APPLICATION

This application is a national stage application of an international patent application PCT/CN2011/082909, filed Nov. 25, 2011, entitled “IMAGE ATTRACTIVENESS BASED INDEXING AND SEARCHING,” which application is hereby incorporated by reference in its entirety.

### BACKGROUND

Web search engines are designed to return search results relevant to a topic entered in a search query. That is, if ‘cat’ is entered in the search query, information and images of a cat are included as the search results. Existing search engines return images similar to the topic entered in the search query. As such, images included as search results may be relevant to the search query topic but still posses varying degrees of quality or aesthetics. For instance, existing search engines may return images of a ‘cat’ that include poor quality or aesthetics as compared to other available images.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

This disclosure describes example methods for estimating image attractiveness. Attractiveness of an image may be defined by perceptual quality, aesthetic sensitivity, and/or affective tone of elements contained within the image. Attractiveness of an image may be estimated by integrating extracted visual features with contextual cues pertaining to the image. In one embodiment, images are selected for indexing based on an estimated attractiveness. In another embodiment, attractive images stored in an index are accessed by a web search engine for inclusion as search results. In this manner, a user may be presented with more attractive images in response to a search query. In another embodiment, a user may receive a group of images as search results and select, through an interface or browser, an option to re-rank the search result images based on attractiveness.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an example architecture for estimating image attractiveness and facilitating attractiveness based indexing and searching.

FIG. 2 is a schematic diagram that illustrates an example application in which an attractiveness estimation engine is incorporated into a web image search engine.

FIG. 3 is a schematic diagram that illustrates an example operation for estimating attractiveness of an image and example applications thereof.

FIG. 4 is a schematic diagram that illustrates example attractiveness based ranking and re-ranking of images included as search results.

FIG. 5 is a flow diagram showing an example method for attractiveness based image indexing.

FIG. 6 is a flow diagram showing an example method for attractiveness based ranking of search result images.

FIG. 7 is a flow diagram showing an example method for attractiveness based re-ranking of search result images.

### DETAILED DESCRIPTION

### Overview

As discussed above, conventional web search engines are designed to return search results relevant to a topic entered in a search query. That is, if ‘cat’ is entered in the search query, information and images of a cat are included as the search results. A large quantity of images is available to include as search results. However, attractiveness or quality of an overall image is not taken into consideration when formulating search results. As such, a user must sift through images of poor quality before finding a satisfying image, or the user may utilize an image of average quality due to a more attractive image not being included in the search results.

This disclosure describes example methods of estimating attractiveness of an overall image. According to this disclosure, attractiveness of an image may be defined by the perceptual quality, aesthetic sensitivity, and/or affective tone of elements contained within the image. In some implementations, these features or characteristics may be weighted equally, while in other implementations these features/characteristics may be weighed differently. However, employing these features/characteristics in combination provides an approach to determining attractiveness of images that is not a subjective characterization of physical attributes associated with a subject, or other single feature, in an image. Instead, objective visual features are analyzed to derive an attractiveness estimate for the features within the image. For instance, an image's visual features associated with perceptual quality, aesthetic sensitivity, and affective tone, may include, lighting, color, sharpness, blur, hue count, and/or color histograms. Additionally or alternatively, attractiveness estimation may be determined based on integrating visual features with contextual data associated with the image. For instance, contextual data may be derived from an Exchangeable Image File Format (EXIF) of a photo image or from web page content where the image is located. Additionally or alternatively, contextual data may be associated with a structure of the web page(s) in which the image is located.

As described herein, an image may include a photograph, a painting, a drawing, clipart, a graph, a map, a chart, a frame of a video, or other still image. The image may be acquired by crawling web pages in the entire web domain or any other corpus of images that can be searched. While being described as being applicable to still images, the techniques described herein may also be applicable to video, animations, moving images, or the like. Generally, image attractiveness estimation includes analyzing visual features associated with perceptual quality, aesthetic sensitivity, and/or affective tone. Perceptual quality represents ability for a user to perceive the topics contained in an image and may be analyzed by determining brightness, contrast, colorfulness, sharpness, and/or blur of an image. The manner in which these features are determined will be covered in detail below.

Another visual feature component that contributes to image attractiveness estimation includes aesthetic sensitivity. Aesthetic sensitivity represents a degree with which an image is said to be beautiful, clear, or appealing. Aesthetic sensitivity of the image may be determined, for instance, by applying well know photography rules such as “the rule of thirds”, simplicity, and visual weight. The “rule of thirds” may be, for instance, extracted from an image by analyzing a subject's location relative to the overall image. Meanwhile simplicity (i.e., achieving the effect of singling out an item from a surrounding) may be determined by analyzing a hue count of an image. As an example, visual weight of an image may be captured by contrasting clarity of a subject region with a non-subject portion of the image.

An additional visual feature component to estimate attractiveness of an image includes affective tone (i.e., a degree with which emotions are invoked by viewing the image). In other words, affective tone may measure vividness or a personal affect a user may associate with the image. Affective tone may contribute to attractiveness estimation by analyzing (i) distribution of both a number and a length of static versus dynamic lines and/or (ii) histograms which quantize an impact of color on emotions. The techniques used for analyzing the affective tone of an image will be covered in greater detail below.

As discussed above, visual features may be analyzed in conjunction with contextual data to derive an image attractiveness score. Contextual data may be mined from EXIF data. EXIF data specifies a setting, a format, and/or environmental condition when an image is captured and may be reflective of image attractiveness. For instance, EXIF data such as exposure program, focal length, ISO speed (i.e., sensitivity of film or a digital image capturing device's sensor to incoming light), exposure time, and/or f-number may be reflective of image attractiveness.

Additionally or alternatively, contextual data can be derived from the content of a web page associated with an image. For instance, text on the web page may be analyzed by a conventional feature selection method, such as information gain (IG), to determine the presence and/or absence of a word. In some implementations, IG may identify a textual word from text sources such as anchor text, image title, surrounding text, Uniform Resource Locator (URL), a web page title, a web page meta description, and/or a web page meta keyword. By identifying the presence and/or absence of specific words in the web page, IG can estimate a positive or negative reflection of attractiveness. For example, “jpg” or “printable” may reflect that the image contained in the webpage has high attractiveness as compared to “gif” or “desktop” which may reflect that the image has low attractiveness.

In addition to web page content, web page structure may provide further contextual data used to estimate image attractiveness. For example, web page structure contextual data may include size of an image in relation to the webpage, a length of the image file name, a number of words surrounding the image, and/or an image position in horizontal and vertical dimensions. Each of these features may be reflective of either a high or a low degree of attractiveness. For instance, images with a structurally long file name, and/or positioned near the center of the web page may correlate to higher attractiveness than an image with a structurally short file name or a position in a corner of the web page.

Image attractiveness may be employed by a multitude of applications. By way of example and not limitation, images may be selectively indexed according to attractiveness. Indexed images may be accessed, for example, by a search engine in order to return attractive images following a search query. For instance, images which are not only relevant but also visually attractive may be promoted in search results. At times, presenting search result images ranked by attractiveness may not always be desired. Thus, alternatively, search result images not currently ranked by attractiveness may be re-ranked to present images with a greater attractiveness score or rank ahead of images with a lower attractiveness score or rank. For instance, a user may elect, after receiving search results, to re-rank the results by making a selection in a user interface or search engine window.

The detailed discussion below begins with a section entitled “Illustrative Architecture”, which describes in detail an example attractive based indexing and searching architecture for implementing the techniques described herein. This section also describes an example flow of operations within the architecture as a user searches with images indexed with attractiveness. A second section entitled “Illustrative Attractive Based Indexing and Searching Methods” follows.

This brief introduction, including section titles and corresponding summaries, is provided for the reader's convenience and is not intended to limit the scope of the claims, nor the proceeding sections.

### Illustrative Architecture

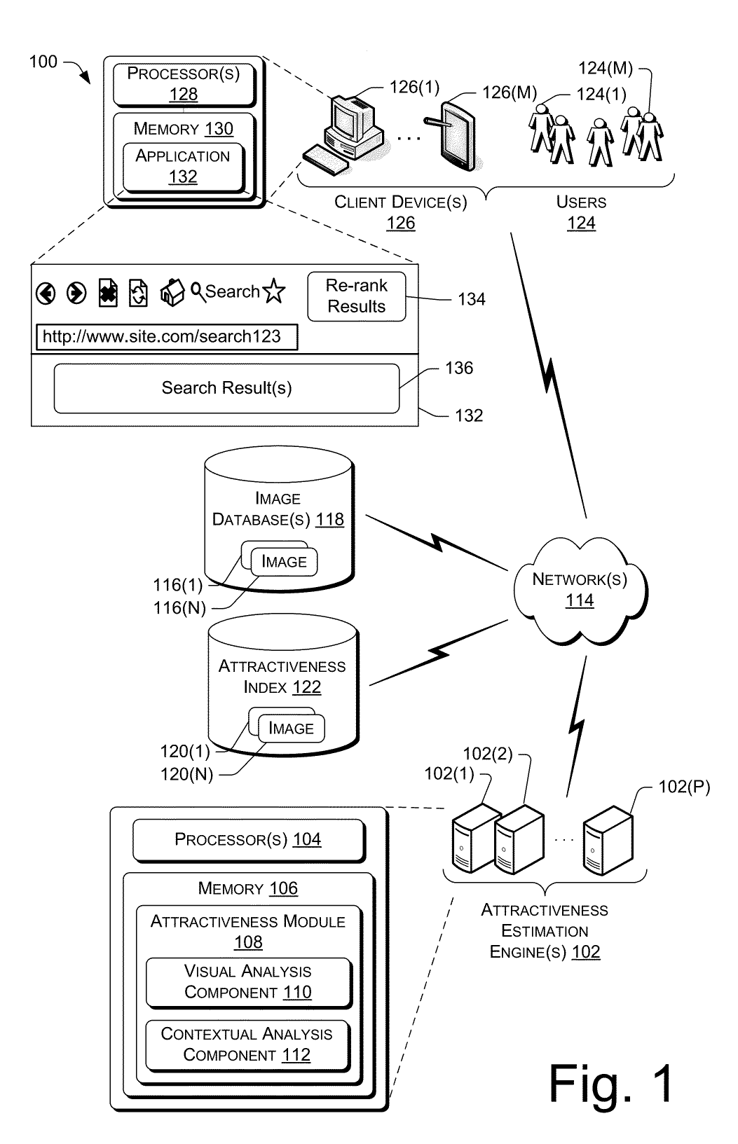

FIG. 1 is a schematic diagram of an example computing architecture 100 that may implement the described techniques for (i) determining attractiveness of an image and (ii) applying image attractiveness to an index, ranking of search results, and/or re-ranking of search results.

As illustrated, the architecture 100 includes an attractiveness estimation engine 102 to determine image attractiveness. As illustrated, the attractiveness estimation engine 102 includes one or more processors 104 and memory 106 which includes an attractiveness module 108. The one or more processors 104 and the memory 106 enable the attractiveness estimation engine 102 to perform the functionality described herein. The attractiveness module 108 includes a visual analysis component 110 and a contextual analysis component 112.

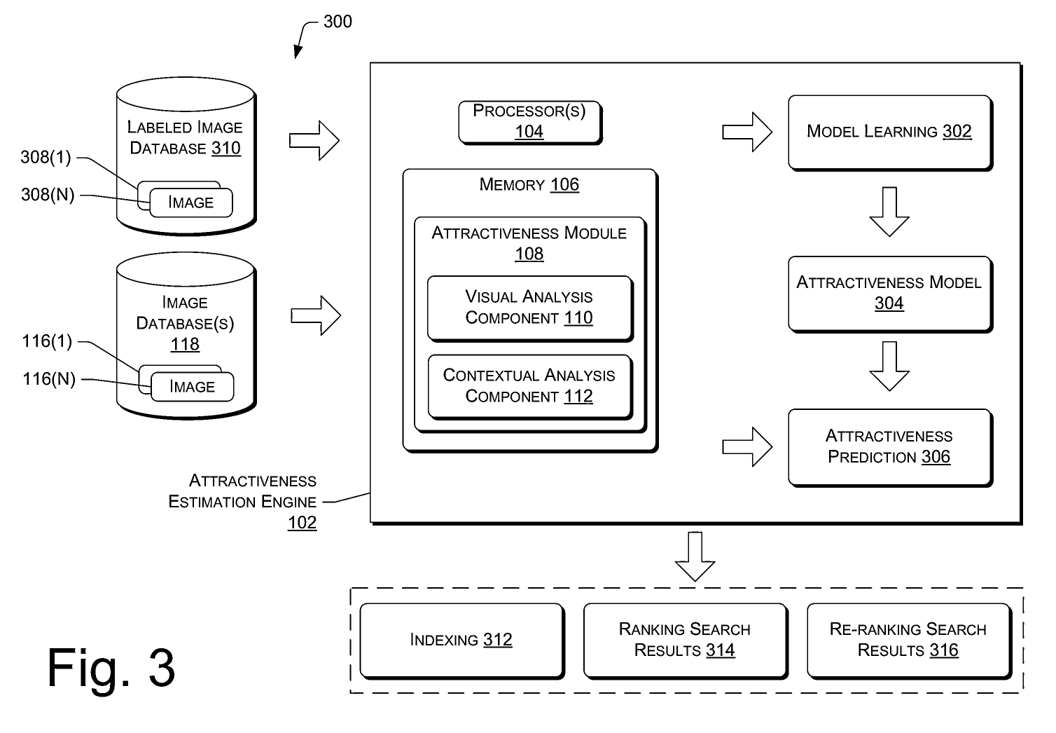

In one implementation, the attractiveness estimation engine 102 may receive or access, via a network 114, an image 116(1), . . . , 116(N) (collectively 116) from an image database 118 and process the image 116 with the attractiveness module 108. For example, the visual analysis component 110 may analyze image features representative of perceptual quality, aesthetic sensitivity, and/or affective tone. Meanwhile, the contextual analysis component 112 may analyze contextual data associated with image EXIF, content of web page(s) where the image is located, and/or structure of web page(s) where the image is located. Details of the analysis performed by the visual analysis component 110 and the contextual analysis component 112 are discussed in detail below with respect to FIG. 3.

In another implementation, the attractiveness estimation engine 102 may send or expose, via network 114, one or more processed images 120(1), . . . , 120(N) (collectively 120) to an attractiveness index 122. In this way, image attractiveness may be applied to an index.

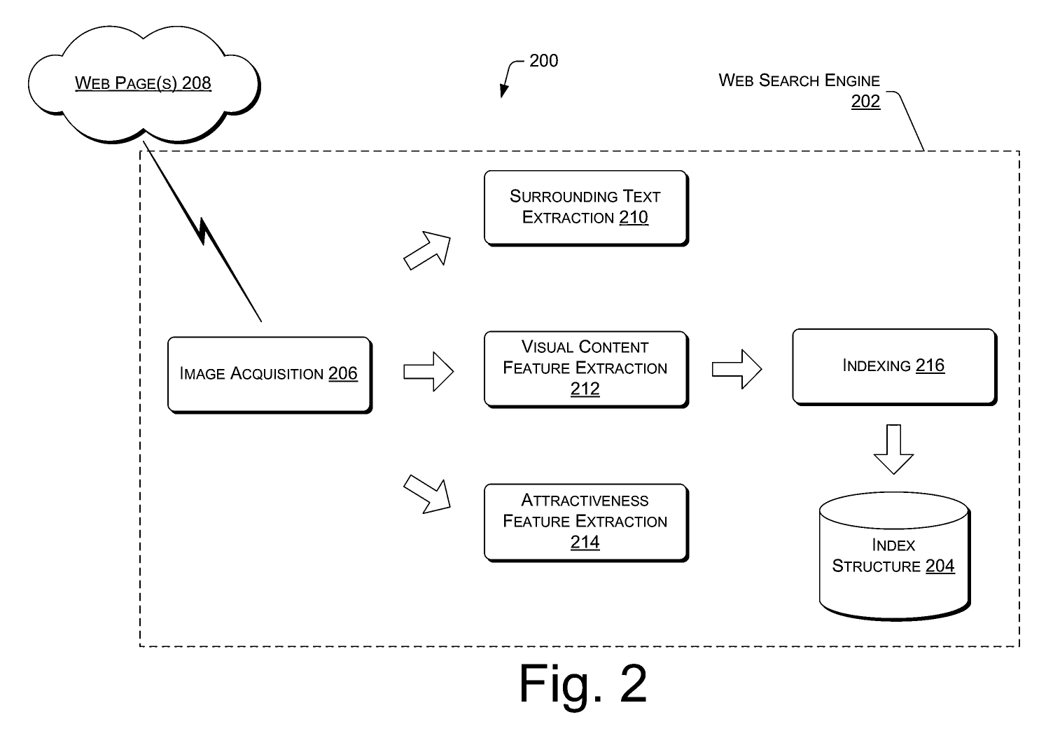

In another implementation, a web search engine, as shown with respect to FIG. 2 below, may employ the attractiveness estimation engine 102 in order to derive an attractiveness based index specific to the web search engine. For example, while architecture 100 demonstrates an example in which the attractiveness index 122 is available to provide search results, alternatively, the attractiveness estimation engine 102 may be integrated into the web search engine. Additionally or alternatively, attractiveness estimation may be incorporated in other applications. For instance, the attractiveness estimation engine 102 may be employed in an email platform (not shown). In that case, images contained in an inbox, or other email folder, may be ranked by attractiveness to present the highest quality images to a user first. Another implementation for the attractiveness estimation engine 102 may include a network, such as a social network or a photo sharing site. In this implementation, images being stored, received, or sent between users may be ranked by attractiveness and surfaced based on their attractiveness. Yet another implementation may include incorporating attractiveness estimation engine 102 into an image capture device. For instance, a user may capture multiple images, but be unable to determine which image has the highest quality and therefore should be saved, kept, or otherwise used later. By incorporating the attractiveness estimation engine 102 into the image capture device, each of the multiple images may be ranked by attractiveness, giving the user a quick and accurate way to locate the highest quality image from among the multiple images that may appear similar to the user. For instance the images may be organized on the image capture device based on attractiveness, may be downloaded from the image capture device based on their attractiveness, and/or may be organize or grouped in an image processing/viewing application of a computing device after receiving the images from the image capture device based on the attractiveness ranking.

An additional implementation for the attractiveness estimation engine 102 may be as a component in an image database. For instance, photo album software may use the engine to rank images by attractiveness. This may make it easier for the end user to identify the highest quality images.

While FIG. 1 illustrates the attractiveness estimation engine 102 as containing the illustrated modules and components, these modules and their corresponding functionality may be spread amongst multiple other actors, each of whom may or may not be related to the attractiveness estimation engine 102.

The network 114 facilitates communication between the attractiveness estimation engine 102, the attractiveness index 122, and the client device 124. For example, the network 114 may be a wireless or a wired network, or a combination thereof. The network 114 may be a collection of individual networks interconnected with each other and functioning as a single large network (e.g., the Internet or an intranet). Examples of such networks include, but are not limited to, personal area networks (PANs), local area networks (LANs), wide area networks (WANs), and metropolitan area networks (MANs). Further, the individual networks may be wireless or wired networks, or a combination thereof.

In this example, the architecture 100 includes the client device 124. In some implementations, a user 126(1), . . . , 126(M) (collectively 126) may interact with the architecture 100 via the client device 126. As illustrated, the client device 124 may be representative of many types of computing devices including, but not limited to, a mobile phone, a personal digital assistant, a smart phone, a handheld device, a personal computer, a notebook or portable computer, a netbook, an Internet appliance, a portable reading device, an electronic book reader device, a tablet or slate computer, a television, a set-top box, a game console, a media player, a digital music player, etc., or a combination thereof.

The upper-left portion of FIG. 1 illustrates information associated with the client device 124 in greater detail. As illustrated, the client device 124 includes one or more processors 128 and memory 130 which further includes an application 132. The one or more processors 128 and the memory 130 enable the client device 124 to perform the functionality described herein. The application 132 presents a user interface (UI) which includes a re-ranking control 134 and one or more search results 136. In one embodiment, the application 132 may receive a search query from user 126, and in response, access the attractiveness index 122 via network 114. Here, the search request may include, for example, a semantic search query, or alternatively, a structured search query. In this embodiment, the application 132 may present search results 136 based on image attractiveness.

In another implementation, the user 126 may interact with the application 132 to filter the search results by image attractiveness. For instance, in response to the user 126 interacting with the re-ranking control 134, images with a higher attractiveness score may be promoted ahead of images with a lower attractiveness score. Additionally or alternatively, the user 126 may interact with the application 132 to filter the images in search results by specific attractiveness characteristics such as brightness, colorfulness, sharpness, and/or color histograms representing a particular emotion. Interacting with the re-ranking control 134 may include selecting a button, a link, a drop down menu, or an icon. Alternatively, the re-ranking control 134 may be selected via a voice or a gesture. While the application 132 performs this functionality in this example, a browser, or another application of the client device 124 may facilitate accessing the attractiveness index 122. Alternatively, some or all of the functionality related to attractiveness indexing, ranking, and/or re-ranking may be performed by a remote server (e.g., as a web service).

Referring still to FIG. 1, the image database 118 may send the image 116 to the attractiveness estimation engine 102 via the network 114. By way of example, the image database 118 may acquire the image 116 by crawling web pages in part or the entire web domain.

In the illustrated example, the attractiveness index 122 may receive from the attractiveness estimation engine 102 processed images 120 that include an attractiveness score. For example, image 120 may be received from the attractiveness estimation engine 102. Alternatively, the attractiveness index 122 may send the image 120 to the application 132 to include as search results 136. For instance, the image 120 may be sent via the network 114 to the client device 124.

In total, the architecture 100 provides an attractiveness based indexing and searching system that is able to determine image attractiveness and index, rank search results, and/or re-rank search results based on image attractiveness. For instance, the architecture 100 may estimate image attractiveness via attractiveness module 108 based on visual and/or contextual features and store the processed images 120 in the attractiveness index 122. Storing the images 120 in this manner may provide images with a high attractiveness rank to the application 132 to include as search results. Additionally, the user 126 may re-rank the results by attractiveness via the re-ranking control 134.

In the illustrated implementation, the attractiveness estimation engine 102 is shown to include multiple modules and components. The illustrated modules may be stored in memory 106. The memory 106, as well as the memory 130, may include computer-readable media in the form of volatile memory, such as Random Access Memory (RAM) and/or non-volatile memory, such as read only memory (ROM) or flash RAM. The illustrated memories are an example of computer-readable media. Computer-readable media includes at least two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

While one example architecture 100 has been illustrated and described, multiple other architectures may implement the techniques described herein.

FIG. 2 is a schematic diagram that illustrates an example application 200 in which the attractiveness estimation engine 102 is incorporated into a web search engine 202 (e.g., textual search engine, image search engine, or the like). By applying the attractiveness estimation engine 102 into the web search engine 202, an index structure 204 specific to the web search engine 202 may be created that takes into account attractiveness (e.g., perceptual quality, aesthetic sensitivity, and/or affective tone) of an image. The web search engine 202 may, in response to receiving a search query, return images ranked by attractiveness from the index structure 204.

In the illustrated example, incorporating attractiveness into the web search engine 202 begins with image acquisition 206. For instance, an image crawler obtains one or more images from one or more web pages 208 from the World Wide Web. Next the web search engine 202 performs surrounding text extraction 210, visual content feature extraction 212, and attractiveness feature extraction 214. In this example, the surrounding text extraction 210 and the visual content extraction 212 is performed with common techniques used by the web image search engine 202 and are not to be confused with techniques described during image attractiveness estimation. Attractiveness feature extraction 214 may be accomplished by employing the attractiveness estimation engine 102 into the web search engine 202. For example, the attractiveness estimation engine 102 is added as a separate component in the web image search engine 202. After surrounding text extraction 210, visual content feature extraction 212, and attractiveness feature extraction 214 from the image, the web search engine 202 indexes 216 the images based on attractiveness of the images. The indexing 216 creates the index structure 204. In one implementation, the index structure 204 may provide image search results ranked by attractiveness. In another implementation, the index structure 204 may provide ranked images in response to receiving selection of the re-ranking control 134. For instance, ranked images are provided in response to user interaction with the web search engine 202.

FIG. 3 is a schematic diagram that illustrates an example operation 300 for estimating attractiveness of an image and example applications thereof. Due to limitations of data storage and computational cost, less than all the images available on the web domain may be selected for attractiveness estimation. As such, the attractiveness estimation engine 102 may include model learning 302. The model learning 302 creates an attractiveness model 304 that may apply attractiveness prediction 306 to unlabeled images.

The example operation 300 illustrates (i) estimating attractiveness of a labeled image 308(1), . . . , 308(N) (collectively 308) from a labeled image database 310 to create the attractiveness model 304 for attractiveness prediction 306 and (ii) estimating attractiveness of the image 116 from the image database 118 via the attractiveness module 108 and/or the attractiveness prediction 306.

In order to generate the model learning 302, the labeled image 308 from a labeled image database 310 must first be processed by attractiveness module 108. The labeled image 308 may, for example, be labeled by a human, a computer, or a combination of human and computer, and may be implemented using any conventional labeling methods. As an example, labels associated with the labeled image 308 may include “excellent”, “good”, “neutral”, or “unattractive”. Alternatively, other types of labels may be implemented, such as, for example, star rankings, numerical scores, or image characteristics (e.g., bright, colorful, vivid, blurry, fuzzy, dark, faded, sharp, warm, cool, low saturation, high saturation, etc.)

In the example operation 300, the labeled image 308 undergoes visual analysis and/or contextual analysis by the attractiveness module 108. As described above, the visual analysis component 110 analyzes a perceptual quality (e.g., brightness, contrast, colorfulness, sharpness, and/or blur), an aesthetic sensitivity (e.g., “the rule of thirds,” simplicity, and/or visual weight of the subject/background), and/or an affective tone (e.g., distribution of both a number and a length of static versus dynamic lines and/or histograms designed to express an emotional impact of image color) of an image.

The visual analysis component 110 may analyze the perceptual quality of the labeled image by determining the brightness, the contrast, the colorfulness, the sharpness, and/or the blur of the labeled image 308. In an example implementation, to determine the brightness and the contrast, the mean (brightness) and standard deviation (contrast) of pixel intensity in gray are analyzed, though other conventional techniques may also be employed. Colorfulness may be determined by analyzing the mean and standard deviation of saturation and hue, or a contrast of colors, for example. Meanwhile, sharpness may be determined by, for example, a mean and standard deviation of a Laplacian image normalized by local average luminance. Blur may be determined by, for example, frequency distribution of an image transformed according to a Fast Fourier Transform (FFT). In addition to analyzing perceptual quality features such as brightness, colorfulness, sharpness, and blur, the visual analysis component 100 may apply a saliency detection algorithm to the labeled image 308. Saliency detection extracts features of objects in images that are distinct and representative. For instance, the visual analysis component 100 may apply the saliency detection algorithm to extract features over the whole image with pixel values reweighted by a saliency map (e.g., an image of extracted saliency features indicating a saliency of a corresponding region or point). Alternatively, the visual analysis component 110 may apply the saliency detection algorithm over a subject region in the image. For instance, the subject region may be detected by a minimal bounding box that contains 90% mass of all saliency weights in order to determine lighting, color, and sharpness of the saliency map reweighted image.

As mentioned above, the visual analysis component 110 may analyze a perceptual quality, an aesthetic sensitivity, and/or an affective tone of an image. The visual analysis component 110 may analyze the aesthetic sensitivity of the labeled image 308 by, for example, applying photography rules such as “the rule of thirds,” simplicity, and visual weight of the subject in relation to the background. In terms of extracting a quality estimate from an image by “the rule of thirds,” an image is divided into nine equal sections or overlaid with a 3×3 grid overlaying the image. The four corners of a center section of the grid are referred to as stress points. Aesthetic sensitivity of an image generally increases the closer a subject is to one of the four stress points. Thus, analyzing “the rule of thirds” of an image may be accomplished by using existing techniques to measure composition of a subject estimated by the nearest distance of the subject to a stress point. In photography, simplicity is a technique that achieves the effect of singling out an item or items from their surroundings. With regard to estimating attractiveness, simplicity may be analyzed by, for example, determining a hue count of an image. For example, an image with a low hue count may be determined to represent a higher quality image than another image with a higher hue count. Alternatively, simplicity of an image may also be determined by determining a spatial distribution of edges in both an original image and a saliency map reweighted image. For instance, generally an unattractive image has a greater number of uniformly distributed edges than an attractive image. Conventional methods are used to determine the hue count and spatial distribution of edges. Lastly, analyzing the visual weight of an image is determined by contrasting clarity between a subject region and the image as a whole. For example, a high quality or attractive image generally has a lower difference in clarity between the subject and the image as a whole than a low quality or unattractive image.

In addition to analyzing a perceptual quality and an aesthetic sensitivity of a labeled image, the visual analysis component 110 may analyze the affective tone (i.e., a degree with which emotions are invoked by viewing the image) of the labeled image 308. For example, the visual analysis component 110 may analyze a distribution of both a number and a length of static versus dynamic lines and/or histograms designed to express an emotional impact of image color. For example, horizontal lines may be associated with a static horizon and may represent calmness, peacefulness, and relaxation; vertical lines that are clear and direct may represent dignity and eternity; slant lines, on the other hand, may be interpreted as being unstable and may represent dynamism. In another example, lines with many different directions may represent chaos, confusion, or action. Longer, thicker and more dominant lines may be interpreted as inducing a stronger psychological effect. To detect significant line slopes in images, a Hough transform may be applied, for example. The lines may be classified as static (e.g., horizontal and vertical) or slant, based on their tilt angle and weighted by length. By analyzing the proportion of static and dynamic lines in the image, affective tone may be determined.

Additionally or alternatively, affective tone may be determined by applying histograms designed to express an emotional impact of image color. To determine an emotion from image color, histograms may be designed to represent a particular emotion, or a set of emotions. For example, a warm-soft histogram may represent an image evoking calmness or peacefulness. In another example, a high saturation-warm histogram may represent an image suggesting happiness or joy whereas a low saturation-cool histogram may be used to infer that the image represents sad or angry emotions. As an example, by applying histograms designed to identify emotions in the image, a degree with which emotions may be evoked by viewing the image may be predicted. In other words, the affective tone of the image may be determined by identifying an emotion associated with or represented by the image.

Though example techniques are provided to determine perceptual quality, aesthetic sensitivity, and affective tone, alternate techniques may also be used.

After the visual analysis component 110 analyzes the labeled image 308, the contextual analysis component 112 may analyze an image's EXIF, content of web page(s) where the image is located, and/or structure of web page(s) where the image is located. EXIF data specifies a setting, a format, and/or environmental condition when an image is captured and may be reflective of image attractiveness. As described above, EXIF data may include exposure (i.e., density of light allowed while capturing an image), focal length, ISO speed (i.e., sensitivity of film or a digital image capturing device's sensor to incoming light), exposure time, and/or f-number. For example, high ISO speed generally leads to reduced image quality when combined with a reduction in the exposure program. Alternatively, long focal length combined with long exposure time generally results in lower image quality than long focal length combined with short exposure time.

In addition to analyzing an image's EXIF, the contextual analysis component 112 may analyze contextual data derived from the content of a web page associated with the image. For instance, text on the web page may be analyzed by a conventional feature selection method, such as information gain (IG), to determine the presence and/or absence of a word. In some implementations, IG may identify a textual word from text sources such as anchor text, image title, surrounding text, Uniform Resource Locator (URL), a web page title, a web page meta description, and/or a web page meta keyword. By identifying the presence and/or absence of specific words in the web page, IG can estimate a positive or negative reflection of attractiveness. In one implementation, text words may be categorized into two or more groups before determining a positive or negative correlation to attractiveness. For example, words such as “wallpaper”, “desktop”, “background”, and “download” may be categorized in a group “image intention” while “printable”, “coloring”, “jpg”, and “gif” may be categorized in another group “image quality”. In an example implementation, words like “desktop” and “gif” may negatively correlate to image attractiveness while words like “background”, “download”, “wallpaper”, “printable”, and “jpg” may positively correlate to image attractiveness.

In addition to web page content, the contextual analysis component 112 may mine contextual data from webpage structure. For instance, image attractiveness may be estimated by analyzing image size in relation to the webpage, a length of the image file name, a quantity of words surrounding the image, and/or an image position in horizontal and vertical dimensions. For instance, attractive images may generally cover a large proportion of the webpage, have a long file name, and/or be positioned near the center of the web page while unattractive images may generally cover a small proportion of the webpage, have a short file name, and/or be positioned in a corner or along an edge of the webpage.

After the attractiveness module 108 analyzes the image to determine visual and contextual features, the model learning 302 may utilize the visual and/or contextual features of the labeled image 308 to generate the attractiveness model 304. For instance, a conventional linear learning method may be employed to learn from the labeled image 308 in order to infer attractiveness. As an example, machine learning may include linear classifiers, such as support vector machines (SVMs). Some visual and contextual features may be linearly correlated with attractiveness, and are thus referred to as “linear features”. However, other visual and contextual features may be non-linear with respect to attractiveness, and are thus referred to as “non-linear features”. In order to obtain linear features for the model learning 302, some non-linear visual and contextual features are transformed to linear data by applying the following equation.

$$g ( {f}_{i} ) = \{ \begin{matrix}exp ( - {σ}_{l} ( {r}_{i} - {f}_{i} ) ) \\ exp ( - {σ}_{r} ( {f}_{i} - {r}_{i} ) )\end{matrix} \begin{matrix}if {f}_{i} \leq {r}_{i} \\ Otherwise\end{matrix} \qquad ( 1 )$$

In the above equation, the parameter rᵢ is a reference point, σₗ (σᵣ) is the scale parameter for transforming data fᵢ that is smaller (or larger) than rᵢ. Non-linear contextual features may include, for example, image size in relation to the webpage, a quantity of words surrounding the image, and/or an image position in horizontal and vertical dimensions. Non-linear visual features may include, for example, clarity, dynamics, sharpness, brightness, contrast, the standard deviation of ‘sharpness’, edge distribution, blur, and hue count.

Referring still to FIG. 3, the model learning 302 creates the attractiveness model 304. By employing the attractiveness model 304, the attractiveness prediction 306 may be applied to images. In one implementation, image attractiveness of a non-labeled image is determined by applying the attractiveness model 304 to the non-labeled image. For example, the attractiveness prediction 306 may estimate attractiveness for the images 116 from the image database 118 based on the attractiveness model 304. Alternatively, the images 116 from the image database 118 may be processed by the attractiveness module 108 prior to the attractiveness prediction 306. The attractiveness prediction 306 may assign an attractiveness score to the labeled image 308 and/or the images 116. The attractiveness score may correspond to one or more of the labels associated with the labeled image 308. Example labels, as described above, may include words such as “excellent”, “good”, “neutral”, or “unattractive”. Alternatively, the attractiveness score may include star rankings, numerical scores, or image characteristics (e.g., bright, colorful, vivid, blurry, fuzzy, dark, faded, sharp, warm, cool, low saturation, high saturation, etc.).

The operation 300 continues with either the labeled image 308 or the images 116, along with their associated attractiveness scores, being made available for indexing 312, ranking search results 314, and/or re-ranking search results 316.

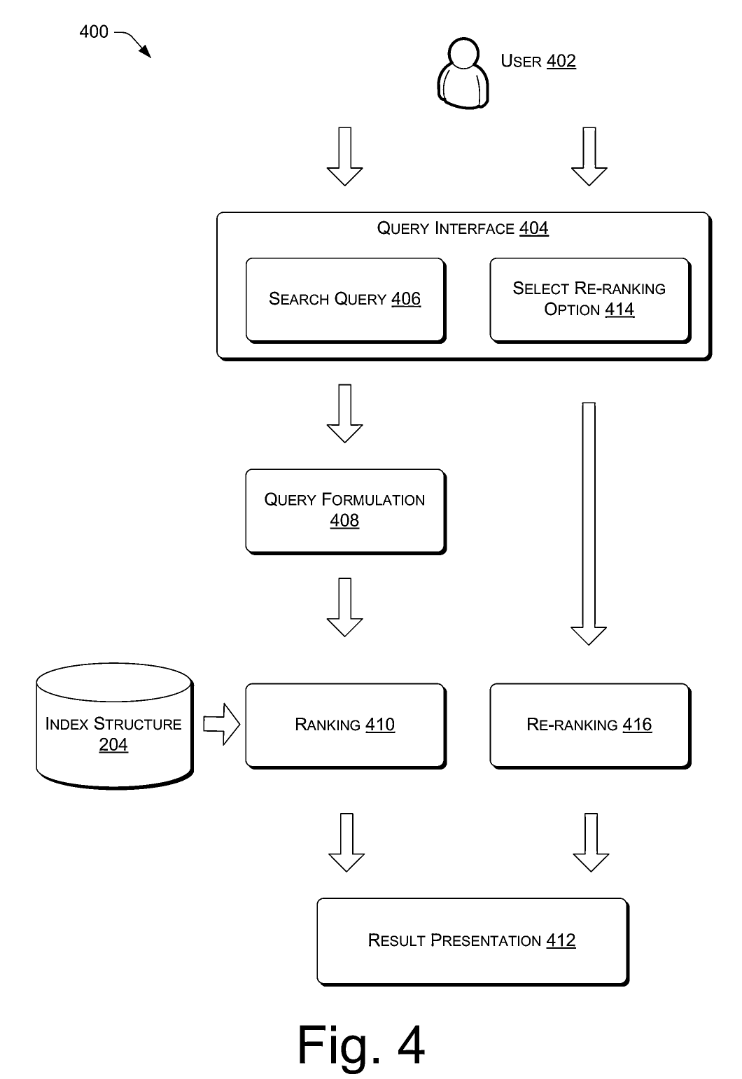

FIG. 4 is a schematic diagram that illustrates an example operation 400 for (i) including attractiveness based ranking of search result images and (ii) re-ranking search result images based on attractiveness.

One example for the operation 400 includes incorporating attractiveness based images as search results. This example begins with a user 402 entering a search query 406 into a query interface 404. The query interface 404 may exist, for instance, in the web search engine 202. The search query 406 undergoes query formulation 408 in order to re-formulate the query. For example, the web search engine 202 may re-formulate the search query 406 into similar and/or new query words to obtain more relevant results as compared to results that may be received if the query is not re-formulated. For instance, the query formulation 408 may include finding synonyms of words, finding morphological forms of words, correcting misspelling, re-writing the original queries, and/or appending additional metawords. Based on the query formulation 408, ranking 410 compiles search results by accessing information and images relevant to the search query 406. For example, the ranking 410 may receive images based on attractiveness from the index structure 204. By accessing images from the index structure 204, the ranking 410 incorporates image attractiveness into the search results. In another implementation, the ranking 410 may incorporate an attractiveness component to compliment conventional ranking components such as relevancy and popularity. In this implementation, the images may be ranked based on conventional machine-learned ranking methodologies. For example, ranking 410 may incorporate an attractiveness score associated with an image into a relevance based ranking model. The relevancy based ranking model may be a rank support vector machine (RankSVM). Alternatively, other conventional ranking methodologies may be employed such as Combined Regression and Ranking (CRR).

Result presentation 412 serves the search results for display. In one example, images with a higher attractiveness score may be served ahead of or more prominently than images with a lower attractiveness score.

Another example of the operation 400 includes re-ranking search result images based on attractiveness. This example begins with the user 402 selecting re-ranking option 414 in the query interface 404. For example, re-ranking option 414 may include the re-ranking control 134. In response to selecting the re-ranking option 414, existing search result images undergo re-ranking 416. For instance, images may be reordered based on their respective image attractiveness score. In one implementation, the re-ranking 416 may determine top ranked images by commonly used protocols such as Precision (Precision@20), Mean Average Precision (MAP@20), or Normalized Discounted Cumulative Gain (NDCG@20). To further limit unattractive images from being included during re-ranking, a metric called Unattractive Rejection (UR) may be used to move unattractive images to lower ranking positions, as defined by the following algorithm:

$$UR = \frac{1}{\vert Q \vert} {\sum }_{i = 1}^{\vert Q \vert} \frac{1}{{rank}_{i}} \qquad ( 2 )$$

In the above algorithm, |Q| denotes a number of queries in test set Q, and rankᵢ is the position of the first “Unattractive” image (e.g., based on an attractiveness score threshold) in the search results of query i. In another implementation, the re-ranking 416 may access, and subsequently serve, images from an index of images with an attractiveness score. In yet another implementation, the re-ranking 416 may access images with an attractiveness score from an index or other source in the background prior to selection of the re-ranking option 414 in anticipation of serving images with an attractiveness score. In the example operation 400, the re-ranking 416 is followed by result presentation 412. For instance, the search result may present images with higher attractiveness scores ahead of, or more prominently than, images with lower attractiveness scores. Alternatively, existing search result images may be reordered based on the ranking of images determined by the commonly used protocols described above.

### Illustrative Attractiveness Based Indexing and Searching Methods

Methods 500, 600, and 700 illustrate example methods of attractiveness based image indexing, attractiveness based ranking of search result images, and attractiveness based re-ranking of search result images, respectively, which may but need not be implemented in the context of the architecture 100 of FIG. 1 and/or using the components and features of FIGS. 2-4. Methods 500, 600, and 700 may additionally or alternatively be performed using different architectures and features. Moreover, the architectures of FIG. 1 and the features of FIGS. 2-4 may be used to implement additional or alternative methods.

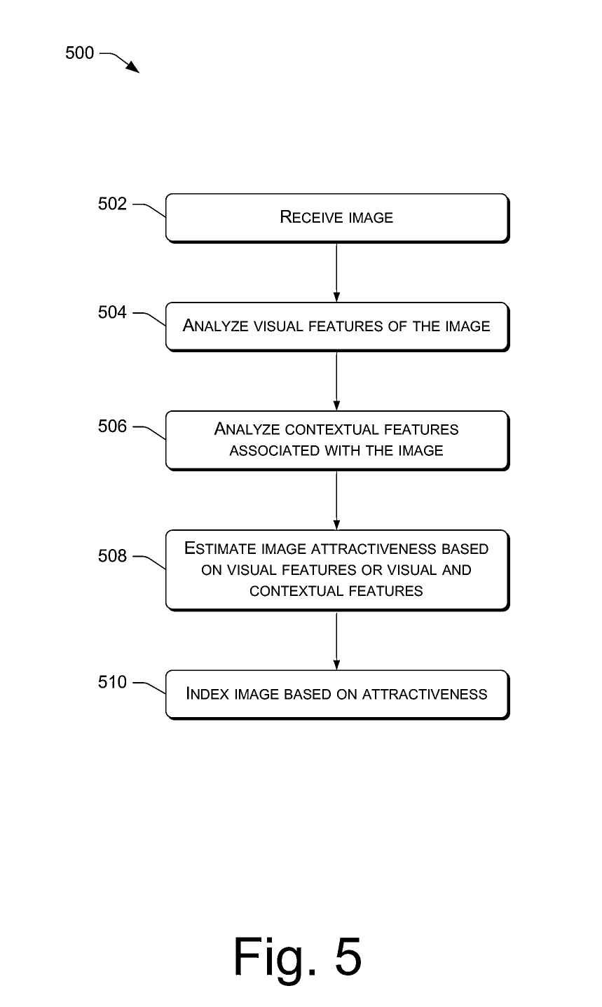

FIG. 5 is a flow diagram showing an example method 500 for attractiveness based image indexing. The method 500 includes, at operation 502, receiving an image. That is, the image may be received from an image database accessible by a network or stored on a device. Alternatively, the image may be received from memory in an image capturing device.

At 504, the method 500 continues by analyzing visual features of the image. For example, visual features are analyzed by the visual analysis component 112 stored in the attractiveness module 108. At operation 506 contextual features associated with the image are analyzed. For instance, the image is processed by the contextual analysis component 112 stored in the attractiveness module 108. Meanwhile, at operation 508, image attractiveness is estimated based on visual features or visual features integrated with contextual features. For instance, the attractiveness estimation engine 102 analyzes features in order to estimate attractiveness.

At 510, the method 500 concludes by indexing the image based on attractiveness. For example, an image may be stored in the attractiveness index 122 in FIG. 1. Alternatively, a processed image may be stored in an index associated with an Internet image search. Attractiveness based image indexing may also take place in other applications, such as photo sharing web sites, as described above.

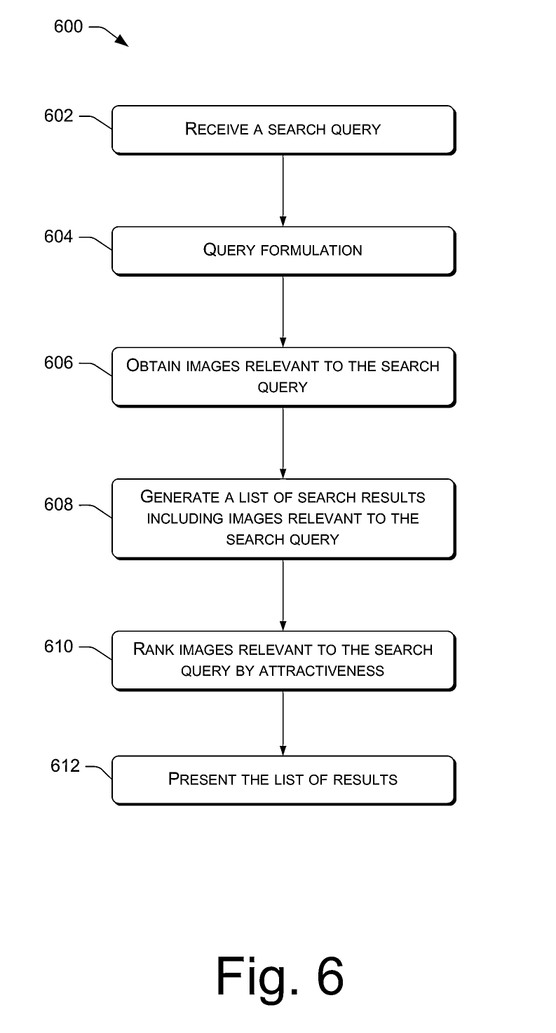

FIG. 6 is a flow diagram showing an example method for attractiveness based ranking of search result images. The method 600 includes, at operation 602, receiving a search query. For example, a search query may be received by a web search engine via the application 132 in client device 126 in FIG. 1.

At 604, the method 600 continues with query formulation. As described above, query formulation may include finding synonyms of words, finding morphological forms of words, correcting misspelling, re-writing the original queries or appending more metawords.

Next, at operation 606, images that are relevant to the search query are obtained. In one embodiment, images with high attractiveness scores or ranks may be obtained from an attractiveness index online and available over a network. In an alternative embodiment, images with high attractiveness scores or ranks may be obtained from an index structure contained in a web search engine. In yet another embodiment, images may be obtained based on a conventional ranking model (e.g., based on relevance) that does not take into account image attractiveness.

Method 600 continues at operation 608 with generating a list of search results including images. For example, the list of search results may include images obtained in operation 606. In embodiments in which operation 606 obtains images with high attractiveness scores or ranks, the list of search results may be ranked by image attractiveness based on the methodologies discussed above with respect to FIG. 4. In embodiments in which operation 606 employs conventional (e.g., relevancy based) ranking models, at 608, the search results may include the images obtained in operation 606 without ranking images by attractiveness.

In embodiments in which operation 606 employs conventional (e.g., relevancy) based ranking models, at operation 610, the search results may be ranked by attractiveness. For instance, ranking of images included as search results may be adjusted by the attractiveness score or rank associated with each image without changing the ranking models. Thus, in this example, only relevant images (i.e., the search results) are ranked by attractiveness rather than all available images on the web. By applying attractiveness only to the search results determined by the conventional (e.g., relevancy based) model, computational reductions may be realized. Method 600 concludes with, at operation 612, presenting the list of results. The list may be, for example, presented by an application on a client device, such as the application 132 in the client device 126 in FIG. 1.

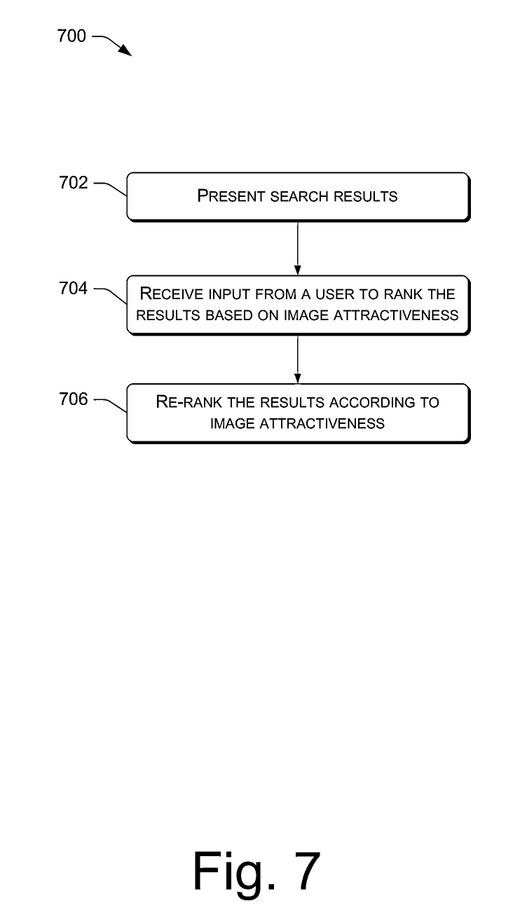

FIG. 7 is a flow diagram showing an example method 700 for attractiveness based re-ranking of search result images. The method 700 begins, at operation 702, by presenting search results. For example, search results are displayed by the application 132 in the client device 126, or other computing device.

At operation 704, a web search engine receives input from a user to rank images in the search results based on attractiveness. For instance, the user 124 makes a selection via an application or browser to re-rank the images in the search results. A user may make a selection by way of selecting a control, voicing a command, or other technique.

Method 700 continues at operation 706 by re-ranking images in the search results by attractiveness. For instance, the web search engine may access an attractiveness index and upload attractive images whereby the most attractive images are promoted in the results. Alternatively, images already included as search results are ranked using traditional ranking methodologies, and subsequently, the images are presented with higher attractiveness ranked images before lower attractiveness ranked images.

Methods 500, 600, and 700 are illustrated as a collection of blocks in a logical flow graph representing a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract. The order in which the methods are described is not intended to be construed as a limitation, and any number of the described method blocks can be combined in any order and/or in parallel to implement the method. Moreover, in some embodiments, one or more blocks of the method may be omitted from the methods without departing from the spirit and scope of the subject matter described herein. For instance, in embodiments in which operation 608 in FIG. 6 includes images with high attractiveness scores or ranks, the list of search results may be ranked by attractiveness and operation 610 may be omitted.

### CONCLUSION

Although the subject matter has been described in language specific to structural features and/or methodological acts, it is to be understood that the subject matter defined in the appended claims is not necessarily limited to the specific features, components, or acts described. Rather, the specific features, components, and acts are disclosed as illustrative forms of implementing the claims. For example, the methodological acts need not be performed in the order or combinations described herein, and may be performed in any combination of one or more acts. Additionally, the features, acts, and/or components may be rearranged, combined in different manners, and/or omitted entirely without departing from the spirit and scope of the subject matter described herein

What is claimed is:

1. A method comprising:
under control of one or more processors configured with executable instructions:
receiving an image from a web page;
extracting one or more visual characteristics from the image;
extracting one or more contextual characteristics of the image or the webpage; and
estimating attractiveness of the image based on the extracted one or more visual characteristics and the extracted one or more contextual characteristics.

2. The method of claim 1, further comprising:
indexing the image based on the estimated attractiveness of the image.

3. The method of claim 1, further comprising:
ranking a result of a search query based at least in part on the estimated attractiveness of the image.

4. The method of claim 1, further comprising:
receiving a search query;
generating a list of results based on the search query;
saving the list of results;
receiving an input from a user to re-order the results based on image attractiveness; and
re-ranking the list of results based on the estimated attractiveness of the image.

5. The method of claim 1, further comprising:
indexing the image based at least in part on the estimated attractiveness of the image;
ranking a result of a search query based on attractiveness of the image; and
re-ranking the results in response to receiving input from a user to re-order the results.

6. The method of claim 1, the one or more visual characteristics including perceptual quality with which a topic of the image can be perceived, aesthetic sensitivity related to a contrast between a subject and a background of the image, and/or affective tone representing a degree with which emotions are invoked by viewing the image.

7. The method of claim 1, the one or more contextual characteristics including Exchangeable Image File Format (EXIF) data describing circumstances under which the image was captured, web page content on a page where the image was located, and/or web page structure of a page on which the image was located.

8. The method of claim 3, the ranking being determined by incorporating an attractiveness component into a ranking model.

9. A method comprising:
under control of one or more processors configured with executable instructions:
receiving a search query;
comparing the search query to an index of images organized based at least in part on attractiveness of the images, attractiveness being estimated from:
one or more visual characteristics of an image; and
one or more contextual characteristics of the image or a web page on which the image appears;
generating a list of results based on relevancy of the search query and the comparison; and
serving the list of results for presentation.

10. The method of claim 9, further comprising:
receiving an input from a user to rank the list of results based on image attractiveness; and
re-ranking the list of results based on the estimated attractiveness of the image responsive to receiving the input from the user.

11. The method of claim 9, the one or more visual characteristics including perceptual quality with which a topic of the image can be perceived, aesthetic sensitivity related to a contrast between a subject and a background of the image, and/or affective tone representing a degree with which emotions are invoked by viewing the image.

12. The method of claim 9, the one or more contextual characteristics including Exchangeable Image File Format (EXIF) data describing circumstances under which the image was captured, web page content on a page where the image was located, and/or web page structure of a page on which the image was located.

13. One or more computer-readable media storing instructions that, when executed by one or more processors, configure the one or more processors to perform acts comprising:
estimating attractiveness of an image from a web page based on:
one or more visual characteristics from the image; and
one or more contextual characteristics from the image or the web page;
selecting the image for indexing according to the attractiveness
storing the selected image in the index;
receiving a search query;
comparing the search query to the index;
including the image in a list of results based on relevancy of the image to the search query and the attractiveness of the image; and
serving the list of results for display.

14. The one or more computer-readable media of claim 13, the one or more visual characteristics including perceptual quality with which a topic of the image can be perceived, aesthetic sensitivity measuring aesthetics associated with the image, and/or affective tone representing a degree with which emotions are invoked by viewing the image.

15. The one or more computer-readable media of claim 14, the one or more visual characteristics being determined by applying a saliency detection algorithm to extract the perceptual quality characteristics including brightness, contrast, colorfulness, sharpness, and/or blur from the image.

16. The one or more computer-readable media of claim 14, the aesthetic sensitivity of the image being determined by analyzing composition of a subject estimated by the nearest distance of the subject to a stress point, hue count and edge distribution, and/or clarity contrast between a subject region and the image.

17. The one or more computer-readable media of claim 14, the affective tone being determined by analyzing distribution of a number of static versus dynamic lines, a length of static versus dynamic lines, and/or histograms which quantize an impact of color to emotions.

18. The one or more computer-readable media of claim 13, the one or more contextual characteristics including Exchangeable Image File Format (EXIF) data describing circumstances under which the image was captured, web page content on a page where the image was located, and/or web page structure of a page on which the image was located, the EXIF data including an exposure program, focal length, ISO speed, exposure time, and/or F-number.

19. The one or more computer-readable media of claim 13, the one or more contextual characteristics including anchor text, image name, text surrounding the image, Uniform Resource Locator (URL), web page title, web page meta description, and/or web page meta keyword.

20. The one or more computer-readable media of claim 18, the web page structure including a size of the image relative to the web page, a length of an image file name, a number of words surrounding the image, a horizontal position of the image on the webpage, and/or a vertical position of the image on the webpage.

21. A method comprising:
under control of one or more processors configured with executable instructions:
receiving a search query;
comparing the search query to an index of images;
generating a list of images that are relevant to the search query based on a ranking model;
ranking the list of images based at least in part on attractiveness of the images; and
serving the list of images ranked based at least in part on attractiveness for presentation as search results.

22. The method in claim 21, the attractiveness of each image being estimated by:
extracting one or more visual characteristics from the image; and
extracting one or more contextual characteristics of the image or the webpage.

23. The method of claim 22, the one or more visual characteristics including perceptual quality with which a topic of the image can be perceived, aesthetic sensitivity related to a contrast between a subject and a background of the image, and/or affective tone representing a degree with which emotions are invoked by viewing the image.

24. The method of claim 22, the one or more contextual characteristics including Exchangeable Image File Format (EXIF) data describing circumstances under which the image was captured, web page content on a page where the image was located, and/or web page structure of a page on which the image was located.
